(19) United States
(12) Patent Application Publication
(10) Pub. No.: US 2006/0064310 A1
(43) Pub. Date: Mar. 23, 2006

(54) Tattoo studio control and management system

(75) Inventors: Geoff Briggs, Surrey (CA); Carol Briggs, Surrey (CA); Stuart Fraser, Duncan (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Crystal Image Artwurks Corp., Surrey (CA)

(21) Appl. No.: 10/944,725

(22) Filed: Sep. 21, 2004

(51) Int. Cl. G06Q 99/00

(52) U.S. Cl. 705/1

(57) ABSTRACT

An apparatus and method for tracking use of an electrical device, such as a tattoo machine, by an operator in the tattoo industry. A power switch is coupled to a power source and a computer system. The computer system executes software which in response to user input activates the power switch, enabling current to flow from the power source to the electrical device coupled to the power switch. The software tracks a time elapsed during which the power switch is activated. The software can generate billing and audit information based on the time during which the power switch is activated.

### TECHNICAL FIELD

This invention relates to the control of electrical equipment in tattoo studios and to maintaining billing records for tasks performed in tattoo studios. Some embodiments of this invention have application for measuring elapsed time during which electrically powered tattoo-related equipment is enabled and using the measured elapsed time for billing and auditing purposes.

### BACKGROUND

The tattooing industry is a growing industry in North America. In order to facilitate expansion by standardizing the operation of tattoo studios, an effective business management system would be of considerable assistance. There exists a need for a suitable business management system that would allow an owner of a tattoo studio to expand while retaining an ability to effectively monitor day-to-day operations of the business. There further exists a need for a system to assist in the efficient running of a tattoo studio.

One problem that tattoo studio owners face is that tattoo artists are often freelancers. Different tattoo artists may work at stations that are separate booths or private rooms and/or are otherwise set apart from the front desk area of a tattoo studio. The owner of a tattoo studio needs some way to track work that is done in the studio to ensure that all parties are properly compensated. Without an effective system in place, some tattoo artists may understate the work that is completed.

A system for managing business for the tattoo industry would enable owners of tattoo studio to better manage their business and better harness market demand.

### SUMMARY OF INVENTION

One aspect of the invention provides apparatus for tracking use of an electrical device by an operator in the tattoo industry. The apparatus includes a computer system coupled to the electrical device via a computer communications link. The computer system contains management software which when executed by the computer system in response to user input selectively causes enabling and disabling of the electrical device. The management software tracks a time elapsed during which the electrical device is enabled.

Another aspect of the invention provides apparatus for tracking use of an electrical device by an operator in the tattoo industry. A front desk terminal has an administrative software interface which in response to user input creates a plurality of On Hold tickets. An operator terminal has a client software interface which in response to user input selects one of the plurality of On Hold tickets. The client software interface at the operator terminal provides start and stop controls for selectively causing enabling and disabling of the electrical device. The management software associates the time elapsed with the selected one of the plurality of On Hold tickets.

Another aspect of the invention provides a software-implemented method for managing a tattoo business. The method involves creating an On Hold ticket containing billing information for a customer. In response to a start or stop command, an electrical device is selectively enabled or disabled. An elapsed time during which the electrical device is enabled is associated with the On Hold ticket.

Further aspects of the invention and features of embodiments of the invention are set out below.

### BRIEF DESCRIPTION OF DRAWINGS

In figures which illustrate non-limiting embodiments of the invention:

FIG. 1 is a schematic representation of a tattoo studio control and management system according to a basic configuration of the invention;

FIG. 2 is a schematic representation of a networked tattoo studio control and management system according to a more complex embodiment of the invention;

FIG. 3 depicts a flowchart of a software algorithm in accordance with another embodiment of the invention;

FIG. 4 is a computer screen of an operator's station showing a plurality of On Hold tickets in accordance with an embodiment of the invention; and

FIG. 5 depicts a computer screen showing an On Hold ticket in accordance with the embodiment of FIG. 4.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The invention provides a control and management system for use in the tattoo industry. A system according to the invention may include a point of sale and inventory system. The system controls the enabling or disabling of an electrical device such as a tattoo machine. The system records and adds to a customer's billing records amounts of time during which the tattoo machine is enabled. The system may enable and disable the tattoo machine in any suitable manner. In some embodiments, the system controls a power switch to switch on and off the flow of current from a power source to an electrical device. In other embodiments the system enables or disables the electrical device without interrupting the power source. The system may optionally include features which allow a tattoo studio owner to manage all stock, sales, customers, purchase histories, artwork and operators (such as artists).

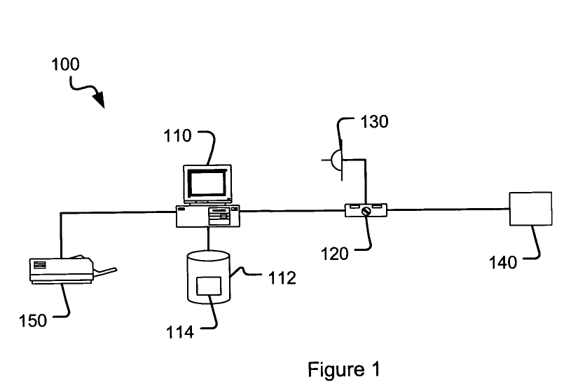

FIG. 1 shows a system 100 having a simple configuration. In system 100, a computer 110 is connected to a computer-controlled power switch 120. Switch 120 is connected between a power source 130, for example a standard 110 V wall outlet, and an electrical device 140. The electrical device 140 can be a tattoo machine, a laser for tattoo removal or some other electrical device or combination of devices which may be used by an artist or other operator in a tattoo studio and charged to customers on a time-spent basis.

One example of a suitable power switch 120 is the CAI RS232™ software controlled power switch. This switch is controlled by a signal provided by way of a standard 9 pin serial port. The switch is then plugged into power source 130 and the electrical device 140, which may include a power supply, is plugged into switch 120.

Power switch 120 and a power supply incorporated as part of electrical device 140 can be permanently fixed together inside a closed case so that power switch 120 cannot be readily bypassed. This reduces or eliminates the possibility that tattoo artists or other operators might connect an electrical device, including a power supply, to a power source 130 without a connection to the power switch 120 to avoid having time spent tattooing tracked by the studio (a practice known as “skimming”). Further, an alarm or other warning system can be provided to monitor any removal of the electrical device 140 from the power switch 120. Electrical device 140 may be hard wired to power switch 120.

The electrical device may comprise a device for converting voltage and/or current values, sometimes referred to as a power supply, coupled to supply electric power to a second device, such as a tattoo machine. One example of a suitable power supply is the Eikon™ EMS200, which is a common power supply used in the industry for converting voltage and current levels to levels suitable for tattoo machines. However, it is to be understood that a variety of power switches and power supplies may be used to practice the invention. Further, it is to be understood that alternate configurations are also possible, such as configuring the system with a power supply between the power source 130 and the power switch 120.

Program store 112 is accessible to computer 110 and contains management software 114 to be executed by computer 110. While the electrical device 140 is connected to the power switch 120, electrical current will not flow to the electrical device 120 unless the power switch 120 is activated in response to commands provided by management software 114 executed by the computer 110. A printer 150 may be connected to computer 110 for printing invoices and/or artwork.

When system 100 is operated, an operator uses computer 100 to enter, or otherwise retrieve from a database, customer information regarding a customer of the tattoo studio. In response to start, pause or stop commands input by the user, management software 114 causes switch 120 to be turned on or off to allow or prevent flow of current from the power source 130 to the electrical device 140. The management software 114 executed by computer 110 includes a timer to keep track of the time elapsed during which power is connected from the power source 130 to the electrical device 140, enabling the electrical device 140. The system records and adds to a billing record for the customer a total amount of time during which the electrical device 140 is enabled.

The embodiment of FIG. 1 ensures that the time spent with the electrical device 140 enabled is recorded and added to a customer's bill. Management software 114 will not permit an operator to operate the electrical device 140 unless the time during which device 140 is enabled is being added to a valid billing record. This will reduce or eliminate time spent with the electrical device 140 in operation that is not billed through the system. The embodiment can further be set up so that the computer 110 is operated by front desk personnel whereas the electrical device 140 is located in a separate area or booth where it is operated by an operator, such as a tattoo artist.

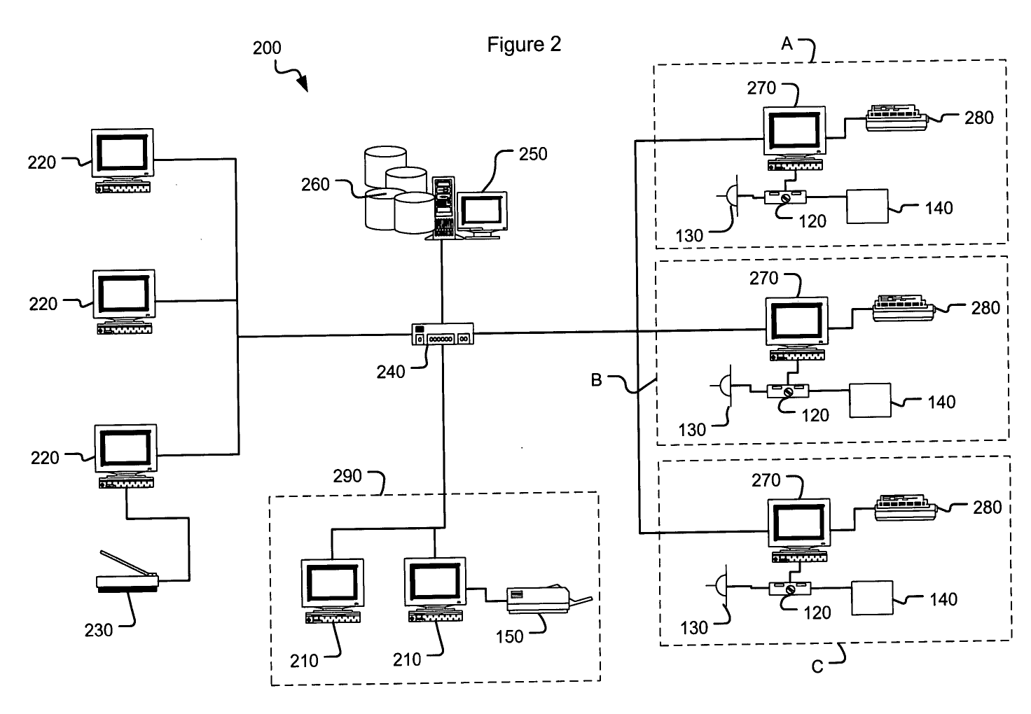

FIG. 2 shows a networked tattoo studio control system 200 in which front desk terminals 210 are connected to artwork browsing terminals 220 via hub 240. Other network topologies are possible, including wired and/or wireless networks. A customer can browse and select artwork from the browsing terminals 220 where the customer can access locally-stored artwork or artwork located from the Internet. Further, a customer can select artwork from a non-electronic source and have the artwork entered into the computer system using a scanner 230 connected to browsing terminal 220. The artwork selected by a customer can be associated with the customer.

A server 250 containing databases 260 storing customer information, operator schedule information, artwork libraries and after-care instructions is connected to the terminals via the hub 240. The server 250 may contain a variety of additional information and programs for use in conjunction with the invention, including accounting software and databases for tracking operator productivity.

Operator terminals 270 in operator booths A, B, and C are connected to the system via hub 240. Each of the operator terminals 270 is connected to control a power switch 120. Current can flow from the power source 130 to the electrical device 140 connected to the power switch 120 only while power switch 120 is turned on. The operator terminals 270 in this embodiment may also be connected to an artwork printer 280 for printing tattoo artwork.

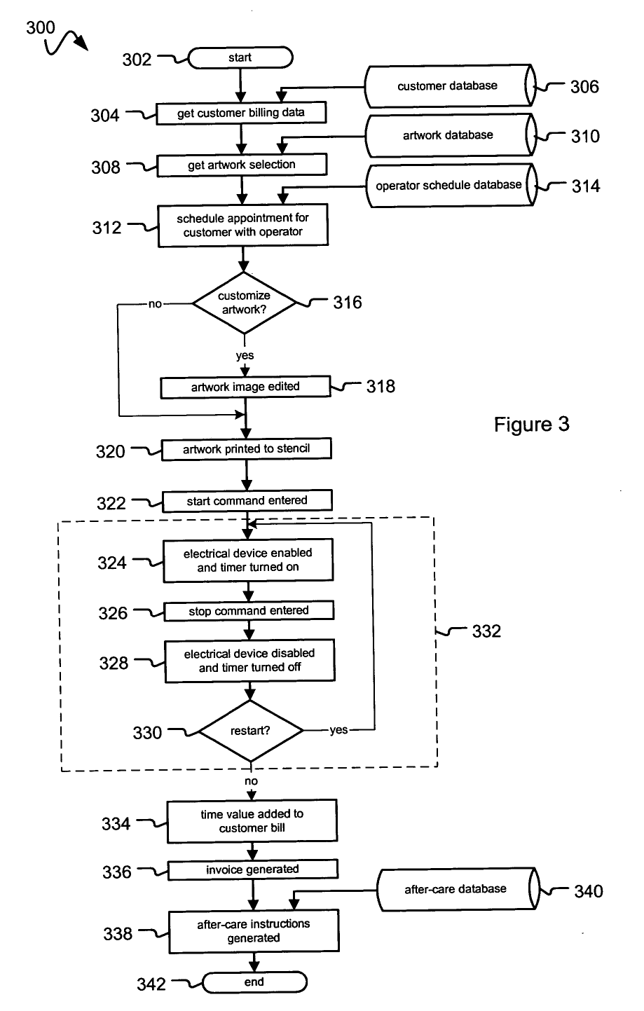

FIG. 3 is a flowchart illustrating the operation of a method 300 controlled by software which controls a system, like system 200, in accordance with the invention. To commence a new customer tattoo and billing sequence, method 300 starts at 302 with inputting customer billing data (step 304). If the customer is an existing customer, the customer billing data may be retrieved from a customer database 306 and may include information items such as one or more of: a customer file number; customer's name; billing address; preferred method of payment; and credit card or other payment information.

In method 300, the customer's selection of artwork is entered into the system at step 308. The artwork may be directly entered into system 200 by receiving a selection from the customer via an artwork browsing station 220 or via a computer connected to the system over the Internet. In alternative embodiments the artwork selection may be entered into the system by any other operator of the software, such as front desk personnel. The artwork may be retrieved from, or linked to, an entry in an artwork database 310. The artwork database 310 may be stored locally in the tattoo studio or may be retrieved from a remote location over the Internet. For example, the artwork database 310 may include a library of tattoo artwork maintained by a third party, such as the Internet-based service currently offered by TattooFinder.com of Longmont, Colo.

In one embodiment, the management software can consolidate the customer billing information and the tattoo artwork selection into an “On Hold” ticket. The On Hold ticket may be created using an administrative software interface accessible from front desk terminal 210. An On Hold ticket is a data structure that associates a customer identifier with information about a job. The On Hold ticket may include customer name and contact information, chosen artwork selection, appointment schedule and billing information. With reference to an operator schedule database 314, an appointment can be scheduled with an available operator in step 312.

When the customer arrives at the appointment, the operator can use operator's terminal 270 to access a client software interface to locate and select the customer's billing information and/or the On Hold ticket so that the time spent during the appointment can correctly be added to the customer's bill. Optionally information contained in the On Hold ticket can be used to bill to an operator for use of the premises. The operator can view the chosen artwork and assess whether the chosen artwork requires customization in step 316. If the artwork requires editing, such as by adding a name to the design, the operator (or a different operator) may edit the artwork using image editing software which may be incorporated in the system in step 318. The system may optionally track the time spent by the operator editing the artwork so that this time may be added to the customer's bill. Editing may be charged to the client at a rate different from tattooing.

Once the artwork is ready, in step 320 the operator may print the artwork to a stencil to be applied to the customer. The artwork may be printed on an optional printer 280 in the operator's station or may be printed on a printer in some other area of the tattoo studio.

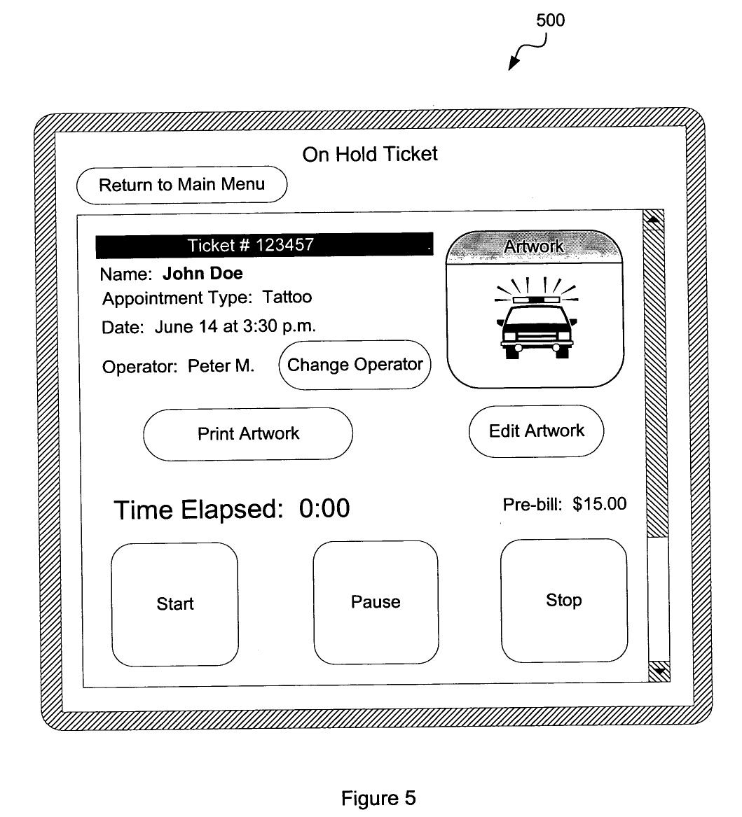

In response to user input of a “start” command at step 322, software 114 activates power switch 120 so that electrical device 140 is enabled at step 324. The start command may be activated in response to input by the operator, such as by pressing a touch screen on a terminal in the operator's station as shown in FIG. 5, or may be activated remotely, such as by personnel at the front desk 290.

Once the start command is entered, in step 324 a timer starts recording the time that the electrical device is enabled. The time value is recorded as time spent working on the customer's account and may be linked to a billable rate, such as the rate of the operator performing the work or a rate for the type of work being performed.

When a “stop” or “pause” command is entered in step 326, the system disables the electrical device and stops recording elapsed time in step 328. The system may record the reason why the operator has caused the device to be disabled.

To re-enable the electric device, a start (or “restart”) command can be entered in step 330, which will also recommence recording of the time spent at step 324. This group of steps, together as group 332, can be repeated until the electrical device is no longer needed in relation to that customer for the session.

When a stop command has been entered and the operator is finished working on a customer for the session, the total time spent using the tattoo machine to work on the customer is added to the customer's bill in step 334. In embodiments in which an On Hold ticket is created, the time spent using the tattoo machine is recorded as part of the customer's On Hold ticket. An invoice can then be generated in step 336 and printed at the front desk 290. Method 300 allows instant communication of billing information between the operator's station A, B, or C and the front desk 290, so that the operator can be free from further involvement in the billing process.

In step 338, after-care instructions relating to the service provided can be automatically retrieved from an after-care database 340 and provided to the customer along with the invoice. Method 300 then comes to an end 342. The nature of the after-care instructions varies depending upon the nature of the work that is performed. For example, after-care instructions relating to a body piercing would be different than after-care instructions relating to a tattoo or to a tattoo removal.

One embodiment of the invention utilizes software written for the Microsoft™ Windows™ 9x/NT/2000/XP platform. Clipper DBF™ file structures can be used for data storage along with Comix CDX™ index files for fast access and searching. Sensitive data can be stored and masked using internal encryption algorithms.

Software implementing the invention may run as a stand-alone package or in a peer-to-peer or server-based network environment. The data drivers may comprise an Advantage Database Engine, a powerful SQL database system, or any other suitable database. It is to be understood that the database and programs mentioned are provided only as examples and are not intended to restrict the scope of the invention.

When the invention is used for more than one tattoo studio, computer systems at the studios can periodically (such as automatically overnight) connect with a head office (via modem or the Internet), to report sales figures and to download updates on inventory, shipping or system upgrades. In certain embodiments, customers can create their own reservations and appointments via the Internet.

Some embodiments of the invention include complete appointment scheduling and time management systems. Such systems may include a system for customer notifications and for follow up communications. Such systems may also include a full purchase order system having supplier histories and even stock value analysis. The software system can run reports keeping track of billings per operator and may be integrated for accounting and tax reporting purposes with one or more business accounting software packages.

Even though the method has been described in relation to a customer purchasing a tattoo, a similar method can be used to provide tattoo-removal services or other similar services. For tattoo removal, the electrical device connected to the power switch will be a laser or other suitable device for tattoo removal. Method steps 304, 312, group 332, and steps 334, 336 and 338 may be performed for tattoo removal, without the additional steps shown in FIG. 3.

In some embodiments an electrical device 140 may include enabling and disabling means therein such that it may be directly controlled by a logic signal from computer 110 or an operator terminal 270 and therefore a power switch would not be required.

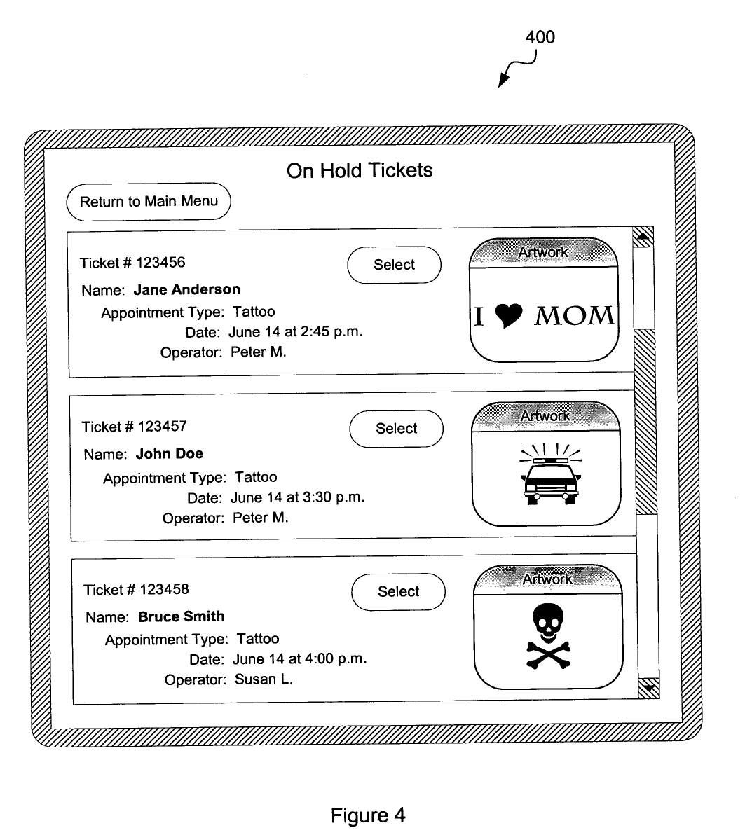

At an appointment, in some preferred embodiments the operator will access system 200 through a local terminal to select an On Hold ticket for the next customer from a list of On Hold tickets as shown on screen 400 of FIG. 4. Selecting one of the On Hold tickets from screen 400 will then display screen 500 of FIG. 5 showing more detailed information about the On Hold ticket including chosen artwork. Screen 500 includes graphical user interface controls for starting, stopping and pausing the operator's electrical device 140. The operator may also edit or print the artwork from his terminal.

In some embodiments, the On Hold ticket can only be created by a terminal 210 at the front desk 290 running an administrative user interface program. The client user interface at the operator booth A, B, or C provides graphical user interface controls for starting, stopping and pausing for selection to enable or disable the electrical device 140 only after an On Hold ticket has been selected. The client user interface at the operator terminal 270 may be unable to create an On Hold ticket. Accordingly, all time spent using the electrical device 140 is recorded and associated with an On Hold ticket created at the front desk 290.

When the operator is ready to start applying the tattoo, the operator will press the start button (i.e. on the screen) to enable his tattoo machine. Should the operator or customer need a break, the operator can press a “Pause” button to temporarily disable the electrical device and stop the recording of time. In some embodiments the elapsed time is displayed on screen 500 as shown in FIG. 5.

When the tattoo is complete, the operator will press the “Stop” button, the tattoo machine will be automatically disabled, and operator's time will be added to the customer's On Hold ticket.

The customer can then proceed to the front counter 290 where an invoice will be generated by the system, showing the total cost of the tattoo. In addition to the time-based charge of operation of the tattoo machine, the invoice might include other charges such as a flat fee for artwork, a flat fee or a time-based fee for editing artwork, costs associated with printing the stencil and any other suitable fees and expenses. The customer can then receive after-care instructions and pay at the front counter.

As will be apparent to those skilled in the art in the light of the foregoing disclosure, many alterations and modifications are possible in the practice of this invention without departing from the spirit or scope thereof. For example, software may calculate an amount owing by a customer while the electrical device 140 is enabled and disable the electrical device 140 upon the amount owing attaining a pre-determined monetary value. Accordingly, the scope of the invention is to be construed in accordance with the substance defined by the following claims.

What is claimed is:

1. Apparatus for tracking use of an electrical device by an operator in the tattoo industry, the apparatus comprising
a computer system coupled to the electrical device via a computer communications link, the computer system comprising management software which when executed by the computer system in response to user input selectively causes enabling and disabling of the electrical device, the management software tracking a time elapsed during which the electrical device is enabled.

2. Apparatus as in claim 1 wherein the electrical device comprises a tattoo machine.

3. Apparatus as in claim 1 wherein the electrical device comprises a power supply coupled to a tattoo machine.

4. Apparatus as in claim 1, wherein the computer system comprises
an administrative software interface accessible from a front desk, the administrative software interface in response to user input creates a plurality of On Hold tickets; and
a client software interface accessible from an operator terminal, the client software interface in response to user input selects one of the plurality of On Hold tickets, the client software interface providing start and stop controls for selectively causing enabling and disabling of the electrical device;
and wherein the management software associates the time elapsed with the selected one of the plurality of On Hold tickets.

5. Apparatus as in claim 4, the client software interface providing a pause control for temporarily causing disabling of the electrical device.

6. Apparatus as in claim 4 further comprising
a power switch coupled between the electrical device and a power source;
wherein enabling the electrical device comprises activating the power switch, to permit current to flow from the power source to the electrical device; and
wherein disabling the electrical device comprises deactivating the power switch.

7. Apparatus as in claim 5 wherein the electrical device comprises a tattoo machine.

8. Apparatus as in claim 5 wherein the electrical device comprises a laser for tattoo removal.

9. Apparatus as in claim 5 wherein the computer system comprises an operator station, the computer system further executing image editing software for editing an artwork selection at the operator station.

10. Apparatus as in claim 5 wherein the computer system comprises an artwork browsing station, the artwork browsing station configured to permit a customer to browse, select and purchase one of a plurality of artwork designs.

11. A computer-implemented method for managing a tattoo business, the method comprising
in a computer system creating an On Hold ticket containing billing information for a customer;
in response to a start command, enabling an electrical device; and,
in response to a stop command, disabling the electrical device, recording an elapsed time value during which the electrical device was enabled, and associating the elapsed time value with the On Hold ticket.

12. A computer-implemented method as in claim 11 wherein the electrical device comprises a tattoo machine, the method further comprising associating an artwork selection with the On Hold ticket.

13. A computer-implemented method as in claim 12 further comprising
preparing an invoice for the customer reflecting an amount based at least in part on a cost of the artwork selection and a time-based cost of the elapsed time value.

14. A computer-implemented method as in claim 11 further comprising in response to a pause command, temporarily disabling the electrical device.

15. A computer-implemented method as in claim 12 further comprising printing the artwork selection.

16. A computer-implemented method as in claim 11 wherein a front desk terminal is physically separated from an operator terminal, the front desk terminal comprising an administrative software interface which in response to user input creates the On Hold ticket.

17. A computer-implemented method as in claim 16 wherein the operator terminal comprises a client software interface which, in response to user input, provides the start command and the stop command.

18. A computer-implemented method as in claim 11 further comprising calculating an amount owing by the customer while the power switch is activated and deactivating the power switch upon the amount owing attaining a pre-determined monetary value.

19. A computer-implemented method as in claim 12 wherein
enabling an electrical device comprises activating a software-controlled power switch to allow current to flow from a power source to the electrical device; and
wherein disabling the electrical device comprises deactivating the power switch to prevent current from flowing from the power source to the electrical device.

20. A computer-implemented method as in claim 19 further comprising scheduling an appointment with an operator and associating the appointment with the On Hold ticket.

21. A computer-implemented method as in claim 20 further comprising
in response to a pause command, temporarily deactivating the power switch to prevent current from flowing from the power source to the electrical device.

22. A computer-implemented method as in claim 21 comprising
printing a stencil of the artwork selection; and
applying the stencil of the artwork selection to the customer.
